(19) United States
(12) Patent Application Publication
(10) Pub. No.: US 2024/0105201 A1
(43) Pub. Date: Mar. 28, 2024

(54) TRANSIENT NOISE EVENT DETECTION FOR SPEECH DENOISING

(71) Applicant: GN Audio A/S, Ballerup (DK)

(72) Inventor: Alfredo ZERMINI, Ballerup (DK)

(21) Appl. No.: 18/473,604

(22) Filed: Sep. 25, 2023

(30) Foreign Application Priority Data
Sep. 26, 2022 (EP) 22197777.0

(51) Int. Cl. G10L 21/0224; G10L 25/84

(52) U.S. Cl. CPC G10L 21/0224; G10L 25/84

(57) ABSTRACT

A method and apparatus for detecting and removing transient noise in an audio signal, in particular an audio signal containing speech by one or more of the following, determining a plurality of sound labels associated with the audio signal using an SED (Sound Event Detection) module, wherein the SED module comprises a machine learning model configured to divide the audio signal into a number of SED time windows, determining, one or more sound labels associated with each of the number of SED time windows, wherein the one or more sound labels are chosen from a predefined set of sound labels, detecting, based on the plurality of determined sound labels, transient noise in the audio signal, and removing, based on the detected transient noise, transient noise from the audio signal to generate a denoised signal.

### FIELD

The present disclosure relates to a method for denoising an audio signal, in particular an audio signal containing speech.

### BACKGROUND

When denoising (i.e. removing noise from) audio signals using existing denoising algorithms, transient noise events are generally difficult to capture due to their unpredictable nature, whereas such algorithms are usually effective for denoising non-transient noisy speech. Modern machine learning systems, such as neural networks, often require a given time context window, which is, by definition, not available for sudden and/or impulsive noise events. As a result, transient noise events are not captured and filtered out. Also, due to the similarity of their spectra, some of the known denoising algorithms tend to confuse speech with other speech-like signals, which can be considered a transient noise events, such as yawning, coughing, etc.

In addition to this, existing denoising algorithms are generally trained to work in specific environments, such as metro, restaurant, office, etc., which means that they are optimised to work using sets of sound from these specific environments. However, they tend to show weaker performance, whenever there is an out-of-context event, such as a baby crying in an office, a dog barking in a pub, etc.

As a partial solution to these problems, a delay can be introduced to give the denoising algorithm additional time to better process the noisy speech and improve the performance on transient noise. However, introducing delays in a conversation will affect its quality by altering the natural flow of real-time conversation for both speakers.

### SUMMARY

In accordance with the present disclosure, the above-mentioned and other problems are addressed by the disclosed method, audio device and computer readable storage medium, which offer a more specific approach that is optimized to work using short time context windows, is context-blind and is, therefore, better suited for tackling the problem of transient noise event in denoising audio signals.

Disclosed is a method for detecting and removing transient noise in an audio signal, in particular an audio signal containing speech. The method comprises the steps of:
determining a plurality of sound labels associated with the audio signal using an SED (Sound Event Detection) module, wherein the SED module comprises a machine learning model configured to divide the audio signal into a number of SED time windows,
determining one or more sound labels associated with each of the number of SED time windows, for which it is relevant, wherein the one or more sound labels are chosen from a predefined set of sound labels,
detecting, based on the plurality of determined sound labels, transient noise in the audio signal, and
removing, based on the detected transient noise, transient noise from the audio signal to generate a denoised signal.

Transient noise can significantly affect the quality of an audio signal and, in severe cases, make it difficult or even impossible to understand what is being said if the audio signal contains speech.

Transient noise may be defined as sound events, which occur randomly in time and have a time-varying unknown impulse response. Thus, the characteristics of transient noise is not easy to estimate, since both the time of occurrence and the impulse response are unpredictable. Fortunately, it is relatively easy to detect transient noise events, since it will usually be a fast-varying signal with short duration and high amplitude.

The audio signal to be denoised can be any electronic representation of a sound sequence, in particular a sound sequence containing speech. The audio signal may be obtained in a plurality of manners. The audio signal may be received from a far-end station, such as an audio device or a server device. The audio signal may be obtained by retrieving the input audio signal from a local storage on an audio device, which local storage may be a memory of that audio device. The audio signal may be part of an online conference between a far-end device and a near-end device. The audio signal may be a test signal stored on an audio device. The audio signal may be obtained by one or more microphones of an audio device recording an input microphone signal. The input microphone signal may be a media signal in the form of a signal representative of a song, audio of a movie or an audio book. The input microphone signal may be a voice signal recorded during a phone call or another communication session between two or more parties. The input microphone signal may be a signal obtained in real-time, e.g., the input microphone signal being part of an on-going online conference. The input microphone signal may be part of a larger dataset of input microphone signals. The audio signal may be a time domain signal or a frequency domain signal. The input audio signal may be obtained via the processor of an audio device. Thus, the audio signal may be in a variety of different formats, such as spectrograms, mel spectrograms, raw audio, gammatone, mel-frequency cepstral coefficients (MFCC), etc.

In general, the purpose of automatic sound event detection is to identify the type and timing of different types of sound appearing in an audio signal. Each sound event, which is detected within the audio signal, is represented by some kind of temporal indication and some kind of specification of the type of sound detected. In the present invention, the temporal indication is defined by the SED time window, in which the sound event is detected, and the type of sound is specified using a number of sound labels, examples of which are given below. These sound labels may represent sounds, which are wanted in the audio signal, typically different forms of speech, or they may represent sounds, which are characterised as being noise and should, preferably, be removed from the audio signal to improve the quality of the audio signal, make it clearer what is said, etc.

The SED module of the present invention may, for example, be implemented with a deep convolutional neural network, for instance consisting of a stack of six convolutional blocks, followed by a global pooling layer, a linear layer and a final linear layer for the sound event classification. Each convolutional block may consist of two 2D convolutional layers with a variable number of inputs/outputs and batch normalisation, and average pooling is applied to the individual convolutional block.

Having first been trained on a sound event classification dataset, such networks have proven to be able to efficiently extract hidden features from input log-mel spectrograms. The sound event classification dataset may comprise millions of clips from YouTube with an accumulated duration of thousands of hours, comprising terabytes of data, and defining hundreds of different sound event classes. An example of such a dataset is the dataset called AudioSet. Datasets, like the AudioSet, constantly evolve over time and may, at any time, be significantly larger than just a few months earlier.

Like any other algorithms, an SED algorithm requires a time context window. However, SED algorithms (implemented using neural networks) are generally trained to work on transient or short events rather than long and homogeneous background noise as is the case for most denoising algorithms. Thus, unlike existing generic denoising algorithms, which are generally not optimized for targeting transient noise events, SED algorithms are targeted to work more on the prompt part of the audio signal.

The length of the SED time windows may be in the range between 1/10 millisecond and a few milliseconds.

In practice, the SED module may calculate a plurality of probabilities for each SED time window, which probabilities are associated with different sound labels. The sound labels being determined to be associated with that particular SED time window may be the ones having a probability above a certain predefined threshold, such as 5%, 10% or 15%, or it may be the ones, such as one, two or three sound labels, having the highest probability. Also a combination of these two approaches for determining which sound labels should be associated with a given SED time window may be used.

Having detected where transient noise, i.e. representations of sounds of short duration, which are characterised as being noise, is present within the audio signal, the method removes these representations from the audio signal or at least reduces them significantly. As far as possible this is done without affecting the representations of the sounds, typically speech, which are desired to be kept within the audio signal. This results in a denoised audio signal, which can be outputted by an audio device comprising a speaker.

In some embodiments, the predefined set of sound labels comprises a set of noise labels and a set of speech labels.

Apart from differentiating between different types of speech (male speech, female speech, child speech, etc.), SED neural networks can be trained to identify many types of transient noise events and out-of-context events, such as a ring tone or a buzzer sound, sneezing, coughing, a baby crying, a dog barking, a cow mooing, strings or other types of music being played, a car passing, etc.

In some embodiments, the step of detecting transient noise in the audio signal comprises the step of:
detecting noisy activity by registering, for each SED time window, if one or more noise labels have been associated with that specific SED time window.

In some embodiments, the step of detecting transient noise in the audio signal comprises the step of:
detecting voice activity by registering, for each SED time window, if one or more speech labels have been associated with that specific SED time window.

In some embodiments, the step of detecting transient noise in the audio signal comprises the step of:
generating a noise time map by registering, for each SED time window, if a noise marker should be set or not, the noise marker being set if one or more noise labels are associated with the specific SED time window and no speech labels are associated with that specific SED time window.

In order not to remove any of the speech from the audio signal, only noise occurring, when there is no speech in the audio signal, is marked in the noise time map.

In some embodiments, the step of detecting transient noise in the audio signal comprises the step of:
generating a transient noise time map from the noise time map using a predefined maximum threshold value in the form of a positive integer, wherein time intervals in the noise time map consisting of one or more successive SED time windows, for which the noise marker is set, are marked as transient noise if the number of consecutive SED time windows constituting the specific time interval does not exceed the maximum threshold value.

Using a threshold value for the maximum number of SED time windows constituting a transient noise event makes sure that only noise events short enough to be considered “transient” are marked as such in the transient noise time map.

The noise time map may be procedurally generated, e.g., each time an SED time window is labelled, the SED time window may be appended onto the noise time map, this may be continuously carried out. Consequently, the noise time map is continuously updated for each new labelled SED time window. Alternatively, the noise time map may be a buffer of a limited length, e.g., the noise time map may be a buffer with a length of N number of SED time windows, wherein N is the maximum threshold value, then each time a SED time window is appended, the oldest present marker in the buffer may be flushed.

In some embodiments, the maximum threshold value is less than 100, such as less than 20, such as 10.

The optimal value of the maximum threshold depends on several factors, such as the signal sampling rate and the Fourier parameters associated. These Fourier parameters will typically be set depending on the quality of the incoming audio signal.

In some embodiments, only time intervals in the noise time map, for which the number of successive SED time windows constituting the specific time interval equals or exceeds a minimum threshold value, are marked as transient noise, the minimum threshold value being a positive integer not exceeding the maximum threshold value.

Using a threshold value for the minimum number of SED time windows constituting a transient noise event reduces the risk of random activation of the transient noise suppression, not caused by an actual transient noise event.

In some embodiments the minimum threshold value is 2 or larger than 2, such as larger than 5, such as 10.

Like for the maximum threshold value, the optimal value of the minimum threshold depends on several factors, such as the signal sampling rate and the Fourier parameters associated, and it should be set individually on each specific audio device, in which the method is implemented.

In some embodiments, the method comprises the steps of:
generating a transient gain time map, wherein, if a time interval is marked as transient noise in the transient noise time map, the specific time interval is suppressed in the transient gain time map, and
removing transient noise from the audio signal by applying the transient gain map to the audio signal before feeding the audio signal into an NR module to generate a denoised signal.

Applying a transient gain time map based on the transient noise time map on the audio signal before feeding the audio signal to the NR module facilitates the function of the NR module. In this way, a significant part of the transient noise is removed from the audio signal, before it is fed to the NR module. This means that it will be easier for the NR module to denoise that audio signal than if the transient noise had still been present therein.

In some embodiments, the method comprises the step of:
removing transient noise from the audio signal using an NR (Noise Reduction) module, wherein one or more parameters of the NR module is adapted based on the detected transient noise.

The short “reaction time” of an SED neural network makes it very suitable for assisting well-known denoising algorithms (implemented in NR modules) in targeting transient noise events. Another use of the fast-reacting SED neural network could be to temporarily mute or reduce the gain of a microphone in order to remove or reduce short out-of-context noise events, which can be disturbing and can be perceived as unprofessional, especially in official meetings and the like.

In some embodiments, the NR module is configured to divide the audio signal into a number of NR time windows and, based on the detected transient noise, to remove, for each of these NR time windows, transient noise from the part of the audio signal falling within that specific NR time window.

The ability of the NR module to remove transient noise from an audio signal may be increased significantly by means of an SED module as described below.

In some embodiments the method comprises the step of:
adapting one or more parameters for the NR module for each NR time window based on the noise labels corresponding to the one or more SED time windows associated with that specific NR time window.

If the lengths of the NR time windows do not correspond to the lengths of the SED time windows, the values used for adapting the parameters of the NR module for a given NR time window may be obtained by averaging or otherwise weighting the values of the SED time windows corresponding to that specific NR time window.

In some embodiments, the length of the SED time windows is shorter than or equal to the length of the NR time windows.

The SED time windows can be set to a smaller length than the NR time windows to better target shorter transient sound events. This is, in fact, an important reason for using an SED module along with the NR module, the denoising algorithms of the NR module generally requiring relatively long time windows to gain enough context to be able to work properly.

In some embodiments, the parameters for the NR module comprise flags for selecting a subset of weights used in the NR module.

If, for instance, a transient noise of certain type is detected, a corresponding flag in the parameters will ensure that a proper subset of network weights are activated within the NR module, enabling it to better adapt to that given type of transient noise.

In some embodiments, the parameters for the NR module comprise Fourier parameters, such as time window length, hop length, overlap length and/or window type.

Also disclosed is an audio device, such as a set of headphones, speakerphones earbuds, or hearing aids. The audio device comprises:
at least one input unit configured to receive a sound signal,
at least one output unit configured to transmit a sound signal,
at least one processor coupled to the at least one input unit and the at least one output unit, and
a memory storing at least one program.

The at least one program includes instructions for causing the at least one processor to perform the method described above.

The above-described method may be applied in any audio device used for denoising an audio signal, in particular an audio signal containing speech.

The audio device may be configured to be worn by a user in, on, over and/or at the user's ear. The user may wear two audio devices, one audio device at each ear. The two audio devices may be connected, such as wirelessly connected and/or connected by wires, such as a binaural hearing aid system.

The audio device may be a hearable such as a headset, headphone, earphone, earbud, hearing aid, a personal sound amplification product (PSAP), an over-the-counter (OTC) audio device, a hearing protection device, a one-size-fits-all audio device, a custom audio device or another head-wearable audio device. The audio device may be a speakerphone or a soundbar. Audio devices can include both prescription devices and non-prescription devices. The audio device may be a smart device, such as a smart phone.

The audio device may be embodied in various housing styles or form factors. Some of these form factors are earbuds, on the ear headphones or over the ear headphones. The person skilled in the art is aware of different kinds of audio devices and of different options for arranging the audio device in, on, over and/or at the ear of the audio device wearer. The audio device (or pair of audio devices) may be custom fitted, standard fitted, open fitted and/or occlusive fitted.

The input unit of the audio device may be one or more input transducers. The one or more input transducers may comprise one or more microphones. The one or more input transducers may comprise one or more vibration sensors configured for detecting bone vibration. The one or more input transducer(s) may be configured for converting an acoustic signal into an electric input signal. This electric input signal may be an analogue input signal or a digital input signal. The one or more input transducer(s) may be coupled to one or more analogue-to-digital converter(s) configured for converting an analogue input signal into a digital input signal.

The audio device may comprise one or more wireless communication unit(s). The one or more wireless communication unit(s) may comprise one or more wireless receiver(s), one or more wireless transmitter(s), one or more transmitter-receiver pair(s) and/or one or more transceiver(s). At least one of the one or more wireless communication unit(s) may be coupled to one or more antenna(s). The wireless communication unit may be configured for converting a wireless signal received by at least one of the one or more antenna(s) into an electric input signal. The audio device may be configured for wired/wireless audio communication, e.g., enabling the user to listen to media, such as music or radio and/or enabling the user to perform phone calls. The audio device may be configured for wireless communication with one or more electronic devices, such as another audio device, a smartphone, a tablet, a computer and/or a smart watch. The audio device may comprise a connector for wired communication, via a connector, such as by using an electrical cable, for instance with one or more microphones.

The processor of the audio device may be configured for processing one or more electric input signals. The processing may comprise compensating for a hearing loss of the user, i.e., apply frequency dependent gain to input signals in accordance with the user's frequency dependent hearing impairment. The processing may comprise performing feedback cancelation, echo cancellation, beamforming, tinnitus reduction/masking, noise reduction, noise cancellation, speech recognition, bass adjustment, treble adjustment and/or processing of user input. The processor may be a processor, an integrated circuit, an application, functional module, etc. The processor may be implemented in a signal-processing chip or a printed circuit board (PCB). The processor may be configured to provide one or more electric output signals based on the processing of the one or more electric input signals.

The output unit of the audio device may be an output transducer. The output transducer may be a loudspeaker. The output transducer may be configured for converting an electric output signal form the processor into an acoustic output signal. The output transducer may be coupled to the processor via a magnetic antenna.

The memory of the audio device may include volatile and non-volatile forms of memory.

Also disclosed is a computer readable storage medium storing at least one program, comprising instructions, which, when executed by a processor of an audio device, enable the audio device to perform the method described above.

The term computer readable storage medium is to be understood as any physical medium, which can receive and retain electronic data, including instructions for being executed by a processor, and make the data available for retrieval. Thus, the term encompasses among other things hard disk drives (HDD), solid-state drives (SSD), flash memory devices (such as, for instance, SD cards), optical storage devices, floppy disks, etc.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 is a block diagram schematically illustrating a current state-of-the-art denoising method,

FIG. 2 is a block diagram schematically illustrating a first embodiment of the method disclosed herein,

FIG. 3 is a simplified illustration of the generation of time maps used in the embodiment illustrated in FIG. 2, and

FIG. 4 is a block diagram schematically illustrating a second embodiment of the method disclosed herein.

### DETAILED DESCRIPTION

A few exemplary embodiments of the method are described hereinafter with reference to the figures. It should be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The same references in the form of numbers or letters are used for identical or corresponding parts or elements throughout. Thus, like elements will not necessarily be described in detail with respect to the description of each figure.

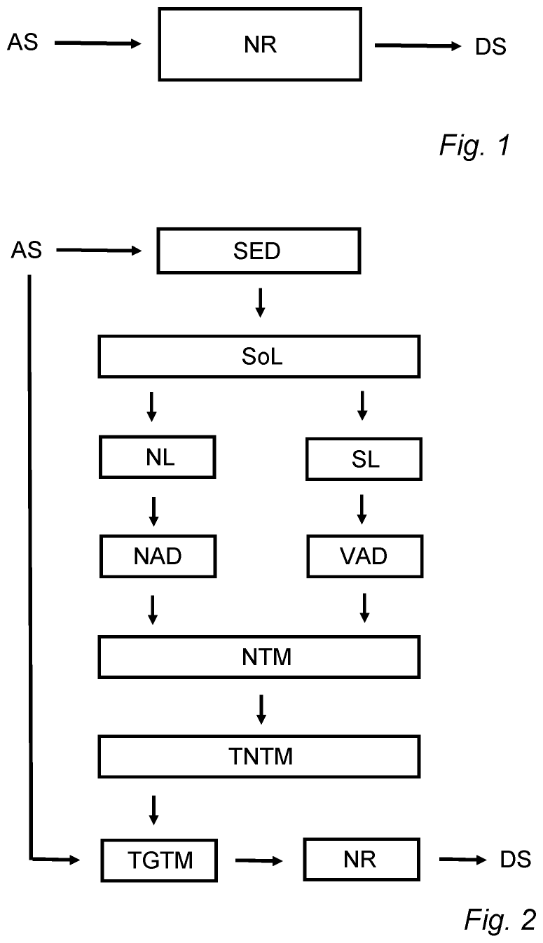

FIG. 1 is a block diagram schematically illustrating a current state-of-the-art denoising method, in which an audio signal AS, typically a speech signal, is fed into an NR module NR. The NR module NR implements some kind of denoising algorithm, which may be based on DSP (digital signal processing) or machine learning (for instance using a neural network). The output from the NR module NR is the denoised signal DS.

FIG. 2 is a block diagram schematically illustrating a first embodiment of the method disclosed herein. In this embodiment, the output from an SED module SED is used to remove transient noise from the audio signal AS before feeding the transient noise-reduced audio signal into an NR module NR as known in the art.

More specifically, the audio signal AS is fed into the SED module SED, from which sound labels SoL (noise labels NL and speech labels SL) are obtained. For each SED time window, a Noise Activity Detection NAD marker is set, if one or more noise labels NL have been associated with that specific SED time window, and a Voice Activity Detection VAD marker is set, if one or more speech labels SL have been associated with that specific SED time window.

A noise time map NTM is generated by setting a noise marker for each SED time window, in which a Noise Activity Detection NAD marker is set but no Voice Activity Detection VAD marker is set.

A transient noise time map TNTM is generated from the noise time map NTM by considering all time intervals in the noise time map NTM consisting of one or more successive SED time windows, for which the noise marker is set. Those of such time intervals, for which the number of SED time windows constituting the time interval does not exceed a predefined maximum threshold value, are marked as transient noise TN in the transient noise time map TNTM.

The method may also comprise a minimum threshold interval, so only time interval, for which the number of SED time windows constituting the time interval equals or exceeds the minimum threshold value, are marked as transient noise TN in the transient noise time map TNTM.

A transient gain time map TGTM is generated, in which all time intervals marked as transient noise TN in the transient noise time map TNTM are suppressed, and transient noise is removed from the audio signal AS by applying the transient gain time map TGTM to the audio signal AS before feeding it into an NR module NR for obtaining a denoised signal DS. The transient gain time map TGTM is applied to the audio signal AS in such a way that, for the time intervals, which are marked in the transient noise time map TNTM as transient noise TN, a suppression of the signal SUP takes place, whereas for the remaining time, no suppression of the signal NSUP is applied.

In other words, to summarize this embodiment, the SED module SED and its output are used to mute short unwanted noise events in time intervals, where the speaker is not active, i.e. there is no speech. After that, a classic denoising method using an NR module NR “polishes up” the rest of the noisy bits in the audio signal AS.

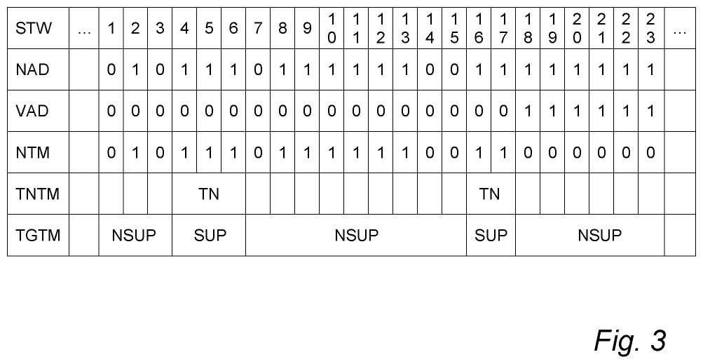

FIG. 3 illustrates schematically a simplified example of how the noise time map, the transient noise map and the transient gain time map can be generated from the NAD markers and VAD markers, the maximum threshold value and the minimum threshold value being set to 5 and 2, respectively.

The first row in the table symbolises a number of SED time windows STW, The 23 SED time windows STW are numbered consecutively with numbers from 1 to 23 for the sake of reference only. In practice, the 23 SED time windows STW listed in the table are to be thought of as constituting only a fragment of a much longer sequence of SED time windows STW, which is indicated by the triple dots before and after the numbers 1-23.

The next two rows indicate if a Noise Activity Detection NAD marker and/or a Voice Activity Detection VAD marker is set for each of the SED time windows STW. For each SED time window STW, the Noise Activity Detection NAD marker is set (marked by the digit 1), if one or more noise labels NL (not shown in FIG. 3) are associated with that specific SED time window STW. Similarly, the Voice Activity Detection VAD marker is set for a SED time window STW, if one or more speech labels SL (not shown in FIG. 3) are associated with that specific SED time window STW.

The fourth row in the table symbolises the noise time map NTM, in which a noise marker is set (again marked by the digit 1) for an SED time window STW, if the Noise Activity Detection NAD marker is set and the Voice Activity Detection VAD marker is not set for that specific SED time window STW.

The maximum threshold value and the minimum threshold value being set to 5 and 2, respectively, time intervals consisting of 2, 3, 4 or 5 consecutive SED time windows STW, in which the noise marker is set in the noise time map NTM are marked as transient noise TN in the transient noise time map TNTM. In the simplified example illustrated in FIG. 3, to such intervals are marked as transient noise TN, whereas two other intervals with noise markers set are not, the first one consisting of only one SED time window STW being too short, the second one consisting of six SED time windows STW being too long.

Finally, a transient gain time map TGTM is generated, in which a suppression SUP of the signal, to which the transient gain time map TGTM is applied, is applied in all time intervals marked as transient noise TN in the transient noise time map TNTM, whereas no suppression NSUP is applied in all other time intervals as indicated in the last row of the table.

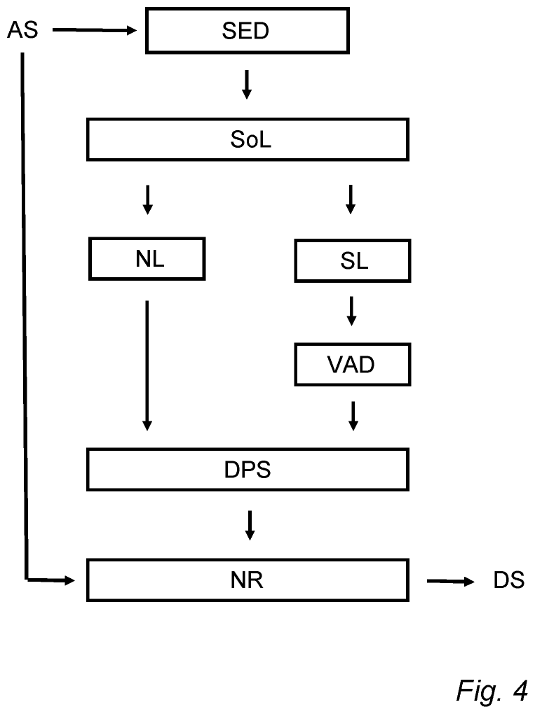

FIG. 4 is a block diagram schematically illustrating a second embodiment of the method disclosed herein. This embodiment is similar to the current state-of-the-art method shown in FIG. 1 with the exception that the denoising algorithm in an NR module NR is guided using the output from an SED module SED. Thus, the sound labels SoL from the SED module are used to set up the parameters DPS of the denoising algorithm to better take into account transient noise and, in general, to improve the overall performance of the denoising algorithm.

More specifically, the audio signal is not only fed into the NR module NR, but also into the SED module SED, the output of which is sound labels SoL (noise labels NL and speech labels SL) for each SED time window.

The noise labels are used to set up the denoising method parameters DPS for each NR time window, whereas the speech labels SL can be used for voice activity detection VAD and provide some other useful information (speaker gender, language, etc.) to better fine-tune the denoising parameters.

### ITEMS

1. A method for detecting and removing transient noise in an audio signal, in particular an audio signal containing speech, which method comprises the steps of:
determining a plurality of sound labels associated with the audio signal using an SED (Sound Event Detection) module, wherein the SED module comprises a machine learning model configured to divide the audio signal into a number of SED time windows,
determining one or more sound labels associated with each of the number of SED time windows, for which it is relevant, wherein the one or more sound labels are chosen from a predefined set of sound labels,
detecting, based on the plurality of determined sound labels, transient noise in the audio signal, and
removing, based on the detected transient noise, transient noise from the audio signal to generate a denoised signal.

2. The method according to item 1, wherein the SED module calculates a plurality of probabilities for each SED time window, which probabilities are associated with different sound labels and used for determining, which sound labels should be associated with that particular SED time window.

3. The method according to item 2, wherein the sound labels being determined to be associated with a particular SED time window are the ones, which have a probability above a certain predefined threshold, such as 5%, 10% or 15%.

4. The method according to item 2, wherein the sound labels being determined to be associated with a particular SED time window are the ones, whose probability is between the highest probabilities, such as between the one, two or three highest probabilities.

5. The method according to item 2, wherein the sound labels being determined to be associated with a particular SED time window are the ones, which have a probability above a certain predefined threshold, such as 5%, 10% or 15%, and whose probability is between the highest probabilities, such as between the one, two or three highest probabilities.

6. The method according to any of the preceding items, wherein the audio signal is in one of the following formats: spectrogram, mel spectrogram, raw audio, gammatone, mel-frequency cepstral coefficients (MFCC).

7. The method according to any of the preceding items, wherein the predefined set of sound labels comprises a set of noise labels and a set of speech labels.

8. The method according to item 7, wherein the step of detecting transient noise in the audio signal comprises the step of:
detecting noisy activity by registering, for each SED time window, if one or more noise labels have been associated with that specific SED time window.

9. The method according to item 7 or 8, wherein the step of detecting transient noise in the audio signal comprises the step of:
detecting voice activity by registering, for each SED time window, if one or more speech labels have been associated with that specific SED time window.

10. The method according to items 8 and 9, wherein the step of detecting transient noise in the audio signal comprises the step of:
generating a noise time map by registering, for each SED time window, if a noise marker should be set or not, the noise marker being set if one or more noise labels are associated with the specific SED time window and no speech labels are associated with that specific SED time window.

11. The method according to item 10, wherein the step of detecting transient noise in the audio signal comprises the step of:

generating a transient noise time map from the noise time map using a predefined maximum threshold value in the form of a positive integer, wherein time intervals in the noise time map consisting of one or more successive SED time windows, for which the noise marker is set, are marked as transient noise if the number of consecutive SED time windows constituting the specific time interval does not exceed the maximum threshold value.

12. The method according to item 11, wherein the maximum threshold value is less than 100, such as less than 20, such as 10.

13. The method according to item 11 or 12, wherein only time intervals in the noise time map, for which the number of successive SED time windows constituting the specific time interval equals or exceeds a minimum threshold value, are marked as transient noise, the minimum threshold value being a positive integer not exceeding the maximum threshold value.

14. The method according to item 13, wherein the minimum threshold value is 2 or larger than 2, such as larger than 5, such as 10.

15. The method according to any of items 11-14, comprising the steps of:
generating a transient gain time map, wherein, if a time interval is marked as transient noise in the transient noise time map, the specific time interval is suppressed in the transient gain time map, and
removing transient noise from the audio signal by applying the transient gain map to the audio signal before feeding the audio signal into an NR module to generate a denoised signal.

16. The method according to any of items 1-14, comprising the step of:
removing transient noise from the audio signal using an NR (Noise Reduction) module, wherein one or more parameters of the NR module is adapted based on the detected transient noise.

17. The method according to item 16, wherein the NR module is configured to divide the audio signal into a number of NR time windows and, based on the detected transient noise, to remove, for each of these NR time windows, noise from the part of the audio signal falling within that specific NR time window.

18. The method according to item 17 and any of items 7-14, comprising the step of:
adapting one or more parameters for the NR module for each NR time window based on the noise labels corresponding to the one or more SED time windows associated with that specific NR time window.

19. The method according to any of items 17 or 18, wherein the length of the SED time windows is shorter than or equal to the length of the NR time windows.

20. The method according to any of items 16 to 19, wherein the parameters for the NR module comprise flags for selecting a subset of weights used in the NR module.

21. The method according to items 16 to 20, wherein the parameters for the NR module comprise Fourier parameters, such as time window length, hop length, overlap length and/or window type.

22. An audio device, such as a set of headphones, speakerphones earbuds, or hearing aids, comprising:

at least one input unit configured to receive a sound signal,
at least one output unit configured to transmit a sound signal,
at least one processor coupled to the at least one input unit and the at least one output unit, and
a memory storing at least one program,
15 the at least one program including instructions for causing the at least one processor to perform the method according to any of items 1-21.

23. A computer readable storage medium storing at least one program, the at least one program comprising instructions, which, when executed by a processor of an audio device, enable the audio device to perform the method according to any of items 1-21.

### LIST OF REFERENCES

AS Audio signal (input for the algorithm)

DPS Denoising parameter setup

DS Denoised signal (output from the algorithm)

NAD Noise Activity Detection

NL Noise label

NR Noise Reduction module

NSUP No suppression of the signal

NTM Noise Time Map

SED Sound Event Detection module

SL Speech label

SoL Sound label

STW SED time window

SUP Suppression of the signal

TGTM Transient game time map

TN Transient noise

TNTM Transient noise time map

VAD Voice Activity Detection

1. A method for detecting and removing transient noise in an audio signal, in particular an audio signal containing speech, which method comprises the steps of:
determining a plurality of sound labels associated with the audio signal using an SED (Sound Event Detection) module, wherein the SED module comprises a machine learning model configured to divide the audio signal into a number of SED time windows,
determining one or more sound labels associated with each of the number of SED time windows, for which it is relevant, wherein the one or more sound labels are chosen from a predefined set of sound labels,
detecting, based on the plurality of determined sound labels, transient noise in the audio signal, and
removing, based on the detected transient noise, transient noise from the audio signal to generate a denoised signal.

2. The method according to claim 1, wherein the predefined set of sound labels comprises a set of noise labels and a set of speech labels.

3. The method according to claim 2, wherein the step of detecting transient noise in the audio signal comprises the step of:
detecting noisy activity by registering, for each SED time window, if one or more noise labels have been associated with that specific SED time window.

4. The method according to claim 2, wherein the step of detecting transient noise in the audio signal comprises the step of:
detecting voice activity by registering, for each SED time window, if one or more speech labels have been associated with that specific SED time window.

5. The method according to claim 3, wherein the step of detecting transient noise in the audio signal comprises the step of:
generating a noise time map by registering, for each SED time window, if a noise marker should be set or not, the noise marker being set if one or more noise labels are associated with the specific SED time window and no speech labels are associated with that specific SED time window.

6. The method according to claim 5, wherein the step of detecting transient noise in the audio signal comprises the step of:
generating a transient noise time map from the noise time map using a predefined maximum threshold value in the form of a positive integer, wherein time intervals in the noise time map consisting of one or more successive SED time windows, for which the noise marker is set, are marked as transient noise if the number of consecutive SED time windows constituting the specific time interval does not exceed the maximum threshold value.

7. The method according to claim 6, wherein the maximum threshold value is less than 100, such as less than 20, such as 10.

8. The method according to claim 6, wherein only time intervals in the noise time map, for which the number of successive SED time windows constituting the specific time interval equals or exceeds a minimum threshold value, are marked as transient noise, the minimum threshold value being a positive integer not exceeding the maximum threshold value.

9. The method according to claim 8, wherein the minimum threshold value is 2 or larger than 2, such as larger than 5, such as 10.

10. The method according to claim 6, comprising the steps of:
generating a transient gain time map, wherein, if a time interval is marked as transient noise in the transient noise time map, the specific time interval is suppressed in the transient gain time map, and
removing transient noise from the audio signal by applying the transient gain map to the audio signal before feeding the audio signal into an NR module to generate a denoised signal.

11. The method according to claim 1, comprising the step of:
removing transient noise from the audio signal using an NR (Noise Reduction) module, wherein one or more parameters of the NR module is adapted based on the detected transient noise.

12. The method according to claim 11, wherein the NR module is configured to divide the audio signal into a number of NR time windows and, based on the detected transient noise, to remove, for each of these NR time windows, transient noise from the part of the audio signal falling within that specific NR time window.

13. The method according to claim 12, comprising the step of:
adapting one or more parameters for the NR module for each NR time window based on the noise labels corresponding to the one or more SED time windows associated with that specific NR time window.

14. The method according to claim 12, wherein the length of the SED time windows is shorter than or equal to the length of the NR time windows.

15. The method according to claim 11, wherein the parameters for the NR module comprise flags for selecting a subset of weights used in the NR module.

16. The method according to claim 11, wherein the parameters for the NR module comprise Fourier parameters, such as time window length, hop length, overlap length and/or window type.

17. An audio device, such as a set of headphones, speakerphones earbuds, or hearing aids, comprising:
at least one input unit configured to receive a sound signal,
at least one output unit configured to transmit a sound signal,
at least one processor coupled to the at least one input unit and the at least one output unit, and
a memory storing at least one program,
the at least one program including instructions for causing the at least one processor to perform the method according to claim 1.

18. A computer readable storage medium storing at least one program, the at least one program comprising instructions, which, when executed by a processor of an audio device, enable the audio device to perform the method according to claim 1.

19. The method according to claim 2, comprising the step of:
adapting one or more parameters for the NR module for each NR time window based on the noise labels corresponding to the one or more SED time windows associated with that specific NR time window.
